(19) United States
(12) Patent Application Publication
(10) Pub. No.: US 2024/0395244 A1
(43) Pub. Date: Nov. 28, 2024

(54) SYSTEM AND METHOD FOR AUTOMATED SELECTION OF DOMAIN-SPECIFIC SPEECH RECOGNITION MODELS

(71) Applicant: VIQ Solutions Inc., Mississauga (CA)

(72) Inventors: Vahram Edward SUKYAS, Los Angeles, CA (US); Jeffrey G. HOPKINS, Lincoln, RI (US); Sebastien PARÉ, Mississauga (CA); Phani Kumar Srinivas SAVATHAM, Hyderabad (IN); Sateesh PUVVALLA, Hyderabad (IN)

(73) Assignee: VIQ Solutions Inc., Mississauga (CA)

(21) Appl. No.: 18/322,057

(22) Filed: May 23, 2023

(51) Int. Cl. G10L 15/16; G10L 15/01; G10L 15/22; G10L 15/32

(52) U.S. Cl. CPC G10L 15/16; G10L 15/01; G10L 15/22; G10L 15/32

(57) ABSTRACT

Systems, methods, and computer-readable storage media for selection of domain or accent specific speech recognition language models. The system can receive a list of available ASR (Automated Speech Recognition) models, each of which is associated with a category of speech (e.g., a specific industry or accent), and a request for a transcription of an audio file with audio in one of those categories. The system can select a specific ASR model based on a similarity of the specific category of speech of the audio file and the category of speech of the specific ASR model. Then the system can transmit, to an ASR architecture: the specific ASR model; the audio file; and instructions to generate a transcription of the audio file using the specific ASR model within the ASR architecture. The system can then receive, from the ASR architecture, the transcription of the audio file.

### BACKGROUND

### 1. Technical Field

The present disclosure relates to speech recognition, and more specifically to selection of domain-specific speech recognition models

### 2. Introduction

Commercial and Open Source Automatic Speech Recognition (ASR) engines receive audio inputs (e.g., an audio file, a video having an audio track, and/or a live audio stream) and produce a written transcript of that audio. ASR engines are trained on vast amounts of data and aim to recognize as many spoken words as they possibly can. However, when multiple models exist which can be used to convert a given audio to text, identifying which model is likely to produce the best transcription can be computationally complex.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a list of available ASR (Automated Speech Recognition) neural network models, wherein each ASR neural network model listed in the list of available ASR neural network models is associated with a category of speech; receiving, at a computer system, a request for a transcription of an audio file, wherein the audio file is associated a specific category of speech; identifying, via at least one processor of the computer system, a specific ASR neural network model from the list of available ASR neural network models based on a similarity of the specific category of speech of the audio file and the category of speech of the specific ASR neural network model; transmitting, from the computer system to an ASR architecture: the specific ASR neural network model; the audio file; and instructions to generate a transcription of the audio file using the specific ASR neural network model within the ASR architecture; and receiving, from the ASR architecture, the transcription of the audio file.

A system configured to perform the concepts disclosed herein can include: at least one processor; and a non-transitory computer-readable storage medium having instructions stored which, when executed by the at least one processor, cause the at least one processor to perform operations comprising: receiving a list of available ASR (Automated Speech Recognition) neural network models, wherein each ASR neural network model listed in the list of available ASR neural network models is associated with a category of speech; receiving a request for a transcription of an audio file, wherein the audio file is associated to a specific category of speech; identifying, via at least one processor of the computer system, a specific ASR neural network model from the list of available ASR neural network models based on a similarity of the specific category of speech of the audio file and the category of speech of the specific ASR neural network model; transmitting, to an ASR architecture: the specific ASR neural network model; the audio file; and instructions to generate a transcription of the audio file using the specific ASR neural network model within the ASR architecture; and receiving, from the ASR architecture, the transcription of the audio file.

A non-transitory computer-readable storage medium configured as disclosed herein can have instructions stored which, when executed by at least one processor, cause the at least one processor to perform operations which include: receiving a list of available ASR (Automated Speech Recognition) neural network models, wherein each ASR neural network model listed in the list of available ASR neural network models is associated with a category of speech; receiving a request for a transcription of an audio file, wherein the audio file is associated a specific category of speech; identifying, via at least one processor of the computer system, a specific ASR neural network model from the list of available ASR neural network models based on a similarity of the specific category of speech of the audio file and the category of speech of the specific ASR neural network model; transmitting, to an ASR architecture: the specific ASR neural network model; the audio file; and instructions to generate a transcription of the audio file using the specific ASR neural network model within the ASR architecture; and receiving, from the ASR architecture, the transcription of the audio file.

### BRIEF DESCRIPTION OF THE DRAWINGS

FIG. 1 illustrates an example process for generating a transcription of audio;

FIG. 2 illustrates an example of projected scores of available ASR models for a given audio segment;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

Because available ASR models are often limited in their ability to recognize domain-specific audio, or speech spoken by an individual with a heavy accent, systems configured as disclosed herein can be used to identify specialized ASR models, which can provide increased accuracy when transcribing such domain-specific and/or accented audio compared to a generic or non-specialized ASR models. To do so, systems configured as described herein have access to an ASR architecture which can be used with a variety of different ASR models. As the system selects which ASR model would provide the best accuracy for a given audio input (e.g., an audio file, a video having an audio track, and/or a live audio stream), that selected ASR model is provided (with the audio input and any accompanying instructions) to the ASR architecture. The ASR architecture can then convert the audio input to text using the selected ASR model, resulting in a transcription of the audio input.

As new, different, or specialized ASR models are generated, the system can store metrics which can be used to compare the ASR models for accuracy, thus enabling the system to determine which ASR model would be best for a given audio input. For example, a newly initialized system may begin with a single (generic) ASR model, and may begin producing transcriptions using that generic ASR model. Once a more specialized ASR model is added to the possible options for generating the transcriptions, the system can determine which ASR model should be selected—the generic ASR model or the specialized ASR model. The system can, for example, make such a prediction based on information about the audio input, such as if the speakers within the audio input have an accent (standard or non-standard), if they are using vocabulary associated with a particular location and/or industry, etc. When the system determines that the audio belongs to a specialized category (e.g., accent, industry, location, etc.), the system can select an appropriate ASR model based on that category. While in some configurations the category can be singular (e.g., Australian, English with a Spanish accent, Medical vocabulary, Engineering vocabulary, vocabulary associated with New York city, etc.), in other configurations the category can be a combination of more than one aspect of the audio (e.g., Scottish accent and Dance vocabulary, African accent and Cooking vocabulary, English with a Chinese accent and California vocabulary).

The system can identify the category of an audio input through one or more different mechanisms. In some instances, the audio can be accompanied by additional information (i.e., metadata) identifying the source location of the audio, the industry, identities of the speakers, etc. In other cases, the audio can be preprocessed by the system using an ASR model which can identify different categories of speech. In yet other cases, the system can execute multiple ASR models (e.g., in series or in parallel), and track which of the ASR models provide the highest number of transcribed words, or a highest predicted word accuracy confidence score, of the possible models with respect to a given audio input.

In yet other cases, the system can score how an ASR model performs over time with respect to specific categories. For instance, an ASR model may perform very well with respect to English spoken with a Spanish accent, but may not perform well with respect to English spoken with a Portuguese accent. Based on how accurate each ASR model is across multiple categories, the system can score multiple models across multiple categories. When new audio is received, the system can select a specialized ASR model from the available ASR models based on the scoring of the models with respect to the identified category and/or computing power required to execute the specialized ASR model. For example, in some cases a specialized ASR model may be predicted to result in a slightly more accurate transcription, but require substantially more computing power to execute. In such cases, the system may determine, based on the higher computing power requirements and limited improvements in accuracy, to use the lower computing cost model.

Table 1 illustrates an example of multiple ASR models being scored for different categories:

TABLE 1

| | | | | Australian |
|---|---|---|---|---|
| | | | English- | Football |
| | Generic | Medical | Spanish | (Soccer) |
| | ASR | ASR | ASR | ASR |
| | model | model | model | model |
| Category: | Score = 8 | Score = 6 | Score = 7 | Score = 4 |
| American | | | | |
| English | | | | |
| discussing sales | | | | |
| Category: | Score = 5 | Score = 4 | Score = 6 | Score = 8 |
| Scottish accent | | | | |
| discussing | | | | |
| soccer | | | | |
| Category: Cats | Score = 6 | Score = 6 | Score = 7 | Score = 5 |
| Category: | Score = 5 | Score = 9 | Score = 4 | Score = 4 |
| Medicine | | | | |

As illustrated in Table 1, each available ASR model can have a score for each known or detected category, such that as the system detects additional audio associated with a category, the best ASR model for that category can be selected. If a new category of audio is identified, the system can use a generic model, test all of the ASR models against the audio, and/or predict which of the models is most likely to be similar to the newly identified category.

In some configurations, the system can have an equal probability of selecting different ASR models. Alternatively, the system can have a bias, thereby ensuring that no model is selected too often (i.e., that the selections are balanced within a predetermined threshold range), and/or ensuring that no model is selected too infrequently.

The scoring of transcriptions and/or models can provide data on finished transcription jobs. The system can then use this data to compute and track speech recognition accuracy between the models, with the accuracy scores being an input to machine learning models which can predict the best speech recognition model(s) for incoming transcription requests. The ASR models can be scored based on accuracy, however they can also be scored based on cost, power consumption, bandwidth usage, time required for a transcription process to occur, computing cycles/flops, etc. The system can use a combination of the transcription scores (e.g., how accurate the resulting transcriptions are) and the model scores to form an “ASR model selection model,” which can identify which available ASR model(s) should be selected to produce the best transcriptions going forward.

The system can also utilize machine learning, where the system self-corrects over time by using feedback and scores from new transcriptions to adjust which models are selected and/or assigned and under what circumstances those models are selected. This machine learning can, for example, include training a neural network to identify variables which make a difference in the overall quality of the final product/transcription, such as the domains, contexts, topics, job creator, time, length of audio, etc. The machine learning can incorporate a neural network, or (if done without a neural network) can include feedback mechanisms to modify weights associated with different model assignments.

Once an ASR model has been selected, that selected ASR model can be forwarded to an ASR architecture for execution. While initially the selected ASR model may be a generic model, once there are a substantial number of available ASR models the selected model is likely to be a specialized ASR model. In cases where a generic ASR model has already been executed, this means that after executing the generic ASR model a specialized ASR model for the identified category can be executed using the audio (i.e., the two different ASR models can be run in series). The final result of the serial process can be a combination of the generic ASR transcription and the specialized ASR transcription. In cases where there is a conflict between the output of the generic ASR model and the output of the specialized ASR model cases, the system can defer to the specialized ASR transcription. In other cases where a conflict is detected the system can result in forwarding the audio (and/or the conflicting transcriptions) to a human for editing.

The ASR architecture used by the system can, for example, be a transformer architecture, where encoder and decoder blocks are stacked with an attention mechanism sending information between the respective blocks. The ASR architecture can take the audio, divide it into 30 second (or another time period) segments, and process each audio segment using the selected ASR model one by one. For each segment, the ASR architecture can encode the audio and save the position of each word detected, then leverage that encoded information to identify what was said using the decoder. For example, the decoder will decode the encoded audio using the encoded information, resulting in each word. Those decoded/resulting words can then be output as the resulting transcription.

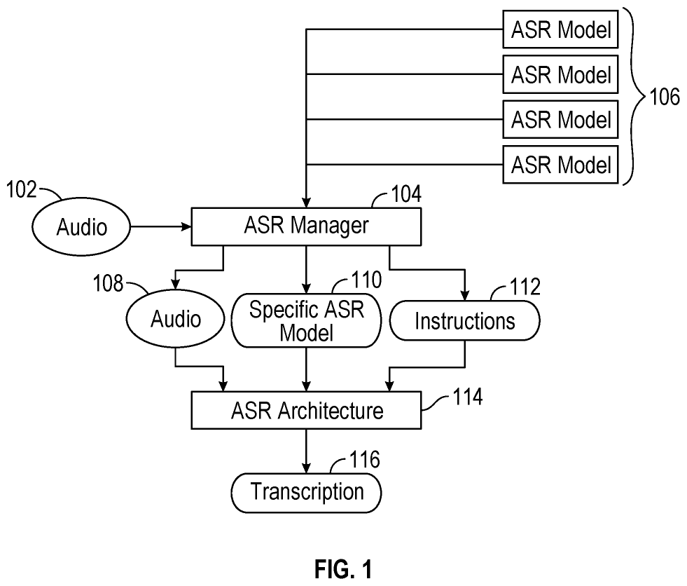

FIG. 1 illustrates an example process for generating a transcription 116 of audio 102. In this example, the audio 102 is being received (e.g., as a live audio stream, as an audio file, as audio connected to a video) by an ASR manager 104. The ASR manager 104 in this example has access to multiple distinct ASR models 106, and can identify which of the available ASR models 106 to use to transcribe the audio 102. The ASR models may be generated, for example, as described in U.S. patent application entitled “SYSTEM AND METHOD FOR TRAINING DOMAIN-SPECIFIC SPEECH RECOGNITION LANGUAGE MODELS” docket number 148695.578506, filed on the same day and incorporated by reference. Likewise, U.S. patent application Ser. No. 17/664,536, filed May 23, 2022, entitled “SYSTEM AND METHOD FOR TRANSCRIPTION WORKFLOW” is hereby incorporated by reference in its entirety. The ASR manager 104 may have pre-configured rules that statically assign how the audio file 102 should be processed by one of the distinct ASR models 106. For example, audio file 102 might be known to originate from the US Auto Insurance industry, and therefore, should be routed to a specialized ASR model 106 that was specifically built for the US Auto Insurance industry domain. In another mode of operation, the ASR model 104 may process audio file 102 through a generic language model, and then perform a Natural Language Understanding algorithm to determine the attributes of what was being discussed in the audio file 102. For example, if the Natural Language Understanding algorithm shows that there is a high likelihood that the matter being discussed is a legal proceeding in a court room, the ASR manager 104 may then perform an additional transcription using a specialized ASR model 106 from the legal domain. Once the ASR manager 104 has selected an ASR model from the available ASR models 106, the ASR manager 104 can send the audio 108, the specific ASR model 110 selected, and any instructions 112 to an ASR architecture 114 for transcription of the audio 108. Preferably, the audio 108 sent to the ASR architecture 114 from the ASR manager 104 is identical to the audio 102 received by the ASR manager 104, though in some configurations the audio 102 received by the ASR manager 104 may be processed or otherwise manipulated before being transmitted to the ASR architecture 114.

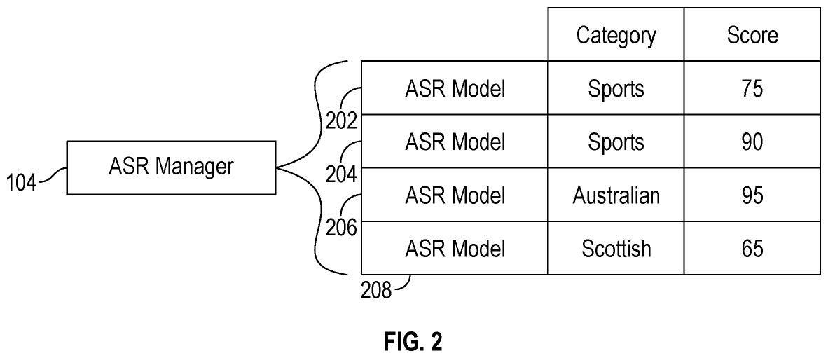

FIG. 2 illustrates an example of projected scores of available ASR models 202, 204, 206, 208 for a given audio segment. As illustrated, the ASR manager 104 of FIG. 1 has access to multiple distinct, available ASR models 202, 204, 206, 208, each of which has an associated category for which is can serve as a specialized ASR model. For each ASR model, the system can have one or more scores. In some configurations, the score can be a predicted level of accuracy for audio received by the ASR manager 104. In other configurations, the score can be a level of accuracy of the model in previous iterations (e.g., an ASR model with a score of 95 has performed with higher accuracy in the past compared to an ASR model with a score of 65, etc.). Such scores can also be category specific, such that an ASR model with a score of 95 for one category may have a score of 70 for another category.

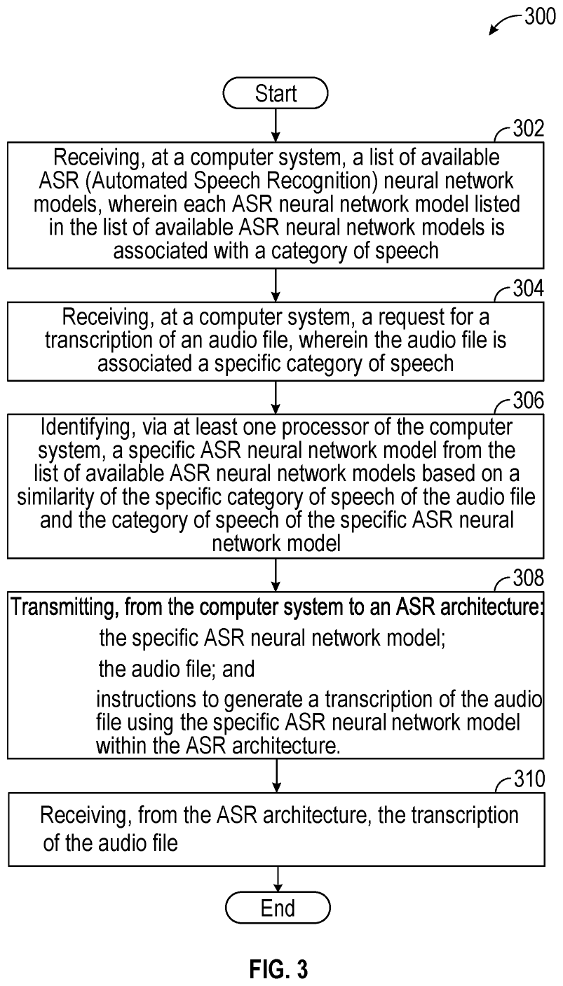

FIG. 3 illustrates an example method embodiment. As illustrated, a system executing the method can receive a list of available ASR (Automated Speech Recognition) neural network models, wherein each ASR neural network model listed in the list of available ASR neural network models is associated with a category of speech (302). The system can then receive a request for a transcription of an audio file, wherein the audio file is associated a specific category of speech (304), and identify a specific ASR neural network model from the list of available ASR neural network models based on a similarity of the specific category of speech of the audio file and the category of speech of the specific ASR neural network model (306). The system then transmits, to an ASR architecture: the specific ASR neural network model; the audio file; and instructions to generate a transcription of the audio file using the specific ASR neural network model within the ASR architecture (308). The system then receives, from the ASR architecture, the transcription of the audio file (310).

In some configurations, the predetermined category can include vocabulary associated with a specific industry.

In some configurations, the predetermined category can include vocabulary from a predefined geographic region.

In some configurations, the predetermined category can include words spoken with an accent (standard or non-standard).

In some configurations, the illustrated method can further include: scoring, via the at least one processor, the specific ASR neural network model based upon accuracy of the transcription compared to a generic transcription of the audio file generated by using a generic ASR neural network model within the ASR architecture, resulting in a score of the specific ASR neural network model, wherein subsequent use of the specific ASR neural network model is based at least in part on the score. In such configurations, the illustrated method can also include: transmitting, from the computer system to the ASR architecture: the generic ASR neural network model; and instructions to generate the generic transcription for the audio file using the generic ASR neural network model within the ASR architecture.

In some configurations, the illustrated method can include: transmitting, from the computer system to a database, a request for the specific ASR neural network model; and receiving, at the computer system from the database, the specific ASR neural network model.

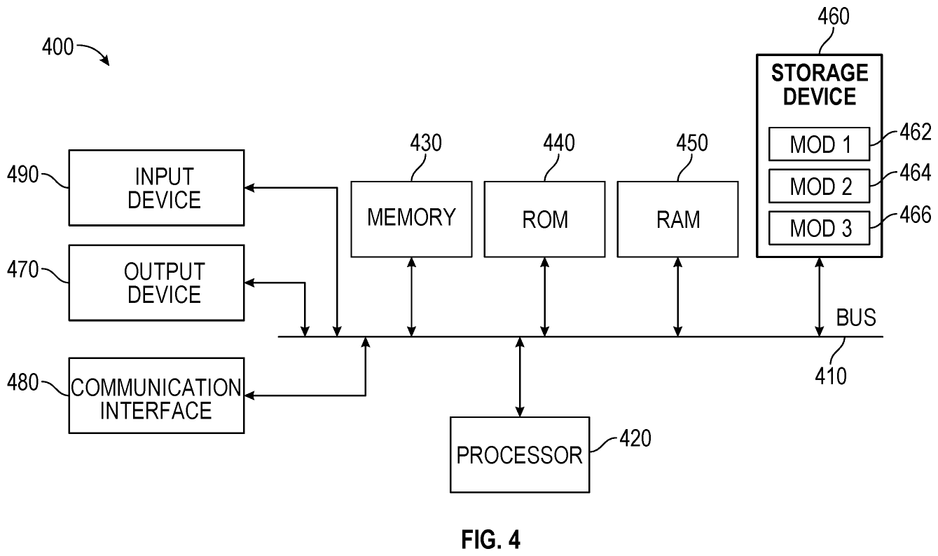

With reference to FIG. 4, an exemplary system includes a computing device 400 (such as a general-purpose computing device), including a processing unit (CPU or processor) 420 and a system bus 410 that couples various system components including the system memory 430 such as read-only memory (ROM) 440 and random access memory (RAM) 450 to the processor 420. The computing device 400 can include a cache of high-speed memory connected directly with, in close proximity to, or integrated as part of the processor 420. The computing device 400 copies data from the system memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The system memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in memory ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, system bus 410, output device 470 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 400 is a small, handheld computing device, a desktop computer, or a computer server.

Although the exemplary embodiment described herein employs the storage device 460 (such as a hard disk), other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, a list of available ASR (Automated Speech Recognition) neural network models, wherein each ASR neural network model listed in the list of available ASR neural network models is associated with a category of speech; receiving, at a computer system, a request for a transcription of an audio file, wherein the audio file is associated to a specific category of speech; identifying, via at least one processor of the computer system, a specific ASR neural network model from the list of available ASR neural network models based on a similarity of the specific category of speech of the audio file and the category of speech of the specific ASR neural network model; transmitting, from the computer system to an ASR architecture: the specific ASR neural network model; the audio file; and instructions to generate a transcription of the audio file using the specific ASR neural network model within the ASR architecture; and receiving, from the ASR architecture, the transcription of the audio file.

The method of any previous clause, wherein the predetermined category comprises vocabulary associated with a specific domain.

The method of any previous clause, wherein the predetermined category comprises vocabulary from a predefined geographic region.

The method of any previous clause, wherein the predetermined category comprises words spoken with an accent (standard or non-standard).

The method of any previous clause, further comprising: scoring, via the at least one processor, the specific ASR neural network model based upon accuracy of the transcription compared to a generic transcription of the audio file generated by using a generic ASR neural network model within the ASR architecture, resulting in a score of the specific ASR neural network model, wherein subsequent use of the specific ASR neural network model is based at least in part on the score.

The method of any previous clause, further comprising: transmitting, from the computer system to the ASR architecture: the generic ASR neural network model; and instructions to generate the generic transcription for the audio file using the generic ASR neural network model within the ASR architecture.

The method of any previous clause, further comprising: transmitting, from the computer system to a database, a request for the specific ASR neural network model; and receiving, at the computer system from the database, the specific ASR neural network model.

A system comprising: at least one processor; and a non-transitory computer-readable storage medium having instructions stored which, when executed by the at least one processor, cause the at least one processor to perform operations comprising: receiving a list of available ASR (Automated Speech Recognition) neural network models, wherein each ASR neural network model listed in the list of available ASR neural network models is associated with a category of speech; receiving a request for a transcription of an audio file, wherein the audio file is associated a specific category of speech; identifying, via at least one processor of the computer system, a specific ASR neural network model from the list of available ASR neural network models based on a similarity of the specific category of speech of the audio file and the category of speech of the specific ASR neural network model; transmitting, to an ASR architecture: the specific ASR neural network model; the audio file; and instructions to generate a transcription of the audio file using the specific ASR neural network model within the ASR architecture; and receiving, from the ASR architecture, the transcription of the audio file.

The system of any previous clause, wherein the predetermined category comprises vocabulary associated with a specific industry.

The system of any previous clause, wherein the predetermined category comprises vocabulary from a predefined geographic region.

The system of any previous clause, wherein the predetermined category comprises words spoken with an accent.

The system of any previous clause, the non-transitory computer-readable storage medium having additional instructions stored which, when executed by the at least one processor, cause the at least one processor to perform operations comprising: scoring specific ASR neural network model based upon accuracy of the transcription compared to a generic transcription of the audio file generated by using a generic ASR neural network model within the ASR architecture, resulting in a score of the specific ASR neural network model, wherein subsequent use of the specific ASR neural network model is based at least in part on the score.

The system of any previous clause, the non-transitory computer-readable storage medium having additional instructions stored which, when executed by the at least one processor, cause the at least one processor to perform operations comprising: transmitting to the ASR architecture: the generic ASR neural network model; and instructions to generate the generic transcription for the audio file using the generic ASR neural network model within the ASR architecture.

The system of any previous clause, the non-transitory computer-readable storage medium having additional instructions stored which, when executed by the at least one processor, cause the at least one processor to perform operations comprising: transmitting, from the computer system to a database, a request for the specific ASR neural network model; and receiving, at the computer system from the database, the specific ASR neural network model.

A non-transitory computer-readable storage medium having instructions stored which, when executed by at least one processor, cause the at least one processor to perform operations comprising: receiving a list of available ASR (Automated Speech Recognition) neural network models, wherein each ASR neural network model listed in the list of available ASR neural network models is associated with a category of speech; receiving a request for a transcription of an audio file, wherein the audio file is associated a specific category of speech; identifying, via at least one processor of the computer system, a specific ASR neural network model from the list of available ASR neural network models based on a similarity of the specific category of speech of the audio file and the category of speech of the specific ASR neural network model; transmitting, to an ASR architecture: the specific ASR neural network model; the audio file; and instructions to generate a transcription of the audio file using the specific ASR neural network model within the ASR architecture; and receiving, from the ASR architecture, the transcription of the audio file.

The non-transitory computer-readable storage medium of any previous clause, wherein the predetermined category comprises vocabulary associated with a specific industry.

The non-transitory computer-readable storage medium of any previous clause, wherein the predetermined category comprises vocabulary from a predefined geographic region.

The non-transitory computer-readable storage medium of any previous clause, wherein the predetermined category comprises words spoken with an accent.

The non-transitory computer-readable storage medium of any previous clause, having additional instructions stored which, when executed by the at least one processor, cause the at least one processor to perform operations comprising: scoring specific ASR neural network model based upon accuracy of the transcription compared to a generic transcription of the audio file generated by using a generic ASR neural network model within the ASR architecture, resulting in a score of the specific ASR neural network model, wherein subsequent use of the specific ASR neural network model is based at least in part on the score.

The non-transitory computer-readable storage medium of any previous clause, having additional instructions stored which, when executed by the at least one processor, cause the at least one processor to perform operations comprising: transmitting to the ASR architecture: the generic ASR neural network model; and instructions to generate the generic transcription for the audio file using the generic ASR neural network model within the ASR architecture.

We claim:

1. A method comprising:
receiving, at a computer system, a list of available ASR (Automated Speech Recognition) neural network models, wherein each ASR neural network model listed in the list of available ASR neural network models is associated with a category of speech;
receiving, at a computer system, a request for a transcription of an audio file, wherein the audio file is associated a specific category of speech;
identifying, via at least one processor of the computer system, a specific ASR neural network model from the list of available ASR neural network models based on a similarity of the specific category of speech of the audio file and the category of speech of the specific ASR neural network model;
transmitting, from the computer system to an ASR architecture:
the specific ASR neural network model;
the audio file; and
instructions to generate a transcription of the audio file using the specific ASR neural network model within the ASR architecture; and
receiving, from the ASR architecture, the transcription of the audio file.

2. The method of claim 1, wherein the predetermined category comprises vocabulary associated with a specific domain.

3. The method of claim 1, wherein the predetermined category comprises vocabulary from a predefined geographic region.

4. The method of claim 1, wherein the predetermined category comprises words spoken with an accent.

5. The method of claim 1, further comprising:
scoring, via the at least one processor, the specific ASR neural network model based upon accuracy of the transcription compared to a generic transcription of the audio file generated by using a generic ASR neural network model within the ASR architecture, resulting in a score of the specific ASR neural network model,
wherein subsequent use of the specific ASR neural network model is based at least in part on the score.

6. The method of claim 5, further comprising:
transmitting, from the computer system to the ASR architecture:
the generic ASR neural network model; and
instructions to generate the generic transcription for the audio file using the generic ASR neural network model within the ASR architecture.

7. The method of claim 1, further comprising:
transmitting, from the computer system to a database, a request for the specific ASR neural network model; and
receiving, at the computer system from the database, the specific ASR neural network model.

8. A system comprising:
at least one processor; and
a non-transitory computer-readable storage medium having instructions stored which, when executed by the at least one processor, cause the at least one processor to perform operations comprising:
receiving a list of available ASR (Automated Speech Recognition) neural network models, wherein each ASR neural network model listed in the list of available ASR neural network models is associated with a category of speech;
receiving a request for a transcription of an audio file, wherein the audio file is associated with a specific category of speech;
identifying, via at least one processor of the computer system, a specific ASR neural network model from the list of available ASR neural network models based on a similarity of the specific category of speech of the audio file and the category of speech of the specific ASR neural network model;
transmitting, to an ASR architecture:
the specific ASR neural network model;
the audio file; and
instructions to generate a transcription of the audio file using the specific ASR neural network model within the ASR architecture; and
receiving, from the ASR architecture, the transcription of the audio file.

9. The system of claim 1, wherein the predetermined category comprises vocabulary associated with a specific industry.

10. The system of claim 1, wherein the predetermined category comprises vocabulary from a predefined geographic region.

11. The system of claim 1, wherein the predetermined category comprises words spoken with an accent.

12. The system of claim 1, the non-transitory computer-readable storage medium having additional instructions stored which, when executed by the at least one processor, cause the at least one processor to perform operations comprising:
scoring specific ASR neural network model based upon accuracy of the transcription compared to a generic transcription of the audio file generated by using a generic ASR neural network model within the ASR architecture, resulting in a score of the specific ASR neural network model,
wherein subsequent use of the specific ASR neural network model is based at least in part on the score.

13. The system of claim 5, the non-transitory computer-readable storage medium having additional instructions stored which, when executed by the at least one processor, cause the at least one processor to perform operations comprising:
transmitting to the ASR architecture:
the generic ASR neural network model; and
instructions to generate the generic transcription for the audio file using the generic ASR neural network model within the ASR architecture.

14. The system of claim 1, the non-transitory computer-readable storage medium having additional instructions stored which, when executed by the at least one processor, cause the at least one processor to perform operations comprising:
transmitting, from the computer system to a database, a request for the specific ASR neural network model; and
receiving, at the computer system from the database, the specific ASR neural network model.

15. A non-transitory computer-readable storage medium having instructions stored which, when executed by at least one processor, cause the at least one processor to perform operations comprising:
receiving a list of available ASR (Automated Speech Recognition) neural network models, wherein each ASR neural network model listed in the list of available ASR neural network models is associated with a category of speech;
receiving a request for a transcription of an audio file, wherein the audio file is associated a specific category of speech;
identifying, via at least one processor of the computer system, a specific ASR neural network model from the list of available ASR neural network models based on a similarity of the specific category of speech of the audio file and the category of speech of the specific ASR neural network model;
transmitting, to an ASR architecture:
the specific ASR neural network model;
the audio file; and
instructions to generate a transcription of the audio file using the specific ASR neural network model within the ASR architecture; and
receiving, from the ASR architecture, the transcription of the audio file.

16. The non-transitory computer-readable storage medium of claim 15, wherein the predetermined category comprises vocabulary associated with a specific industry.

17. The non-transitory computer-readable storage medium of claim 15, wherein the predetermined category comprises vocabulary from a predefined geographic region.

18. The non-transitory computer-readable storage medium of claim 15, wherein the predetermined category comprises words spoken with an accent.

19. The non-transitory computer-readable storage medium of claim 15, having additional instructions stored which, when executed by the at least one processor, cause the at least one processor to perform operations comprising:
scoring specific ASR neural network model based upon accuracy of the transcription compared to a generic transcription of the audio file generated by using a generic ASR neural network model within the ASR architecture, resulting in a score of the specific ASR neural network model,
wherein subsequent use of the specific ASR neural network model is based at least in part on the score.

20. The non-transitory computer-readable storage medium of claim 15, having additional instructions stored which, when executed by the at least one processor, cause the at least one processor to perform operations comprising:
transmitting to the ASR architecture:
the generic ASR neural network model; and
instructions to generate the generic transcription for the audio file using the generic ASR neural network model within the ASR architecture.
